(19) United States
(12) Patent Application Publication
(10) Pub. No.: US 2006/0136073 A1
(43) Pub. Date: Jun. 22, 2006

(54) Ophthalmic surgical system with embedded product catalog

(76) Inventor: Susan M. Kastigar, St. Louis, MO (US)

Correspondence Address: Bausch & Lomb Incorporated, One Bausch & Lomb Place, Rochester, NY, 14604-2701, US

(21) Appl. No.: 11/017,587

(22) Filed: Dec. 20, 2004

(51) Int. Cl. G05B 15/00

(52) U.S. Cl. 700/1

(57) ABSTRACT

An ophthalmic surgical system 10 includes an ophthalmic surgical console 12 and a plurality of surgical modules 14 for performing a plurality of surgical tasks. Surgical console 12 includes a memory 16. A display screen 18 forms a part of surgical console 12 for displaying a variety of surgical information, and the information contained within the memory 16. Display screen 18 displays a catalog of products stored in the memory 16 that may be purchased for use with the surgical console 12 and the plurality of surgical modules 14.

### BACKGROUND OF THE INVENTION

1. Field of the Invention

The present invention relates to ophthalmic surgical systems and more specifically, to ophthalmic surgical systems with display screens for displaying information stored in a memory of the system.

2. Description of Related Art

The present invention relates generally to the field of cataract surgery and more particularly, to surgical systems used for cataract removal as well as vitreoretinal surgery.

With advances in ophthalmic surgical techniques and electronic and software technology, ophthalmic surgical equipment has become increasingly sophisticated and provides the surgeon with ever-increasing flexibility and capability. Most present day ophthalmic surgical systems essentially have a personal computer integrated as part of the surgical console. Sophisticated software associated with the computer and various surgical modules, which themselves may have computers, control many surgical parameters. The control software can be set to control a wide range of surgical instruments, settings, and operating parameters in order to accommodate a wide range of surgical techniques that may be employed by various surgeons or by the needs of a particular type of ophthalmic surgery. In addition, with the use of communications technology such as the internet or telephone lines, much information may be extracted from the surgical system or downloaded into the surgical system from a remote site, such as a manufacturer. Such remote activities may include maintenance and updating of the software for running the surgical system. Remote controlled tutorials on operating the surgical system may also be implemented using the communications link.

Other possible capabilities of an ophthalmic surgical system are disclosed in U.S. Pat. No. 6,648,223 assigned to Alcon Inc. The '223 patent discloses the use of a bar code on a surgical pack, which may identify the contents of the pack and then set the surgical console operating parameters to coincide with the particular pack, which has been read by a bar code reader. The '223 patent also suggests that remote access provides the ability to update the software periodically, as well as providing service diagnosis. In addition, the '223 patent suggests that training and educational materials may be downloaded into the console, as well as pre-operative patient data. The '223 patent also suggests that the operation manual for the surgical system can be downloaded into the system and be updated periodically by the manufacturer.

It would be advantageous to have an ophthalmic surgical system that allows the user to view a catalog of products available for use with the system, as well as information on how to order such products.

### BRIEF DESCRIPTION OF DRAWINGS

FIG. 1 is a perspective view of an ophthalmic surgical system in accordance with the present invention; and

FIG. 2 is a representative example of a display screen for display on the system of FIG. 1.

### DETAILED DESCRIPTION OF THE PREFERRED EMBODIMENT

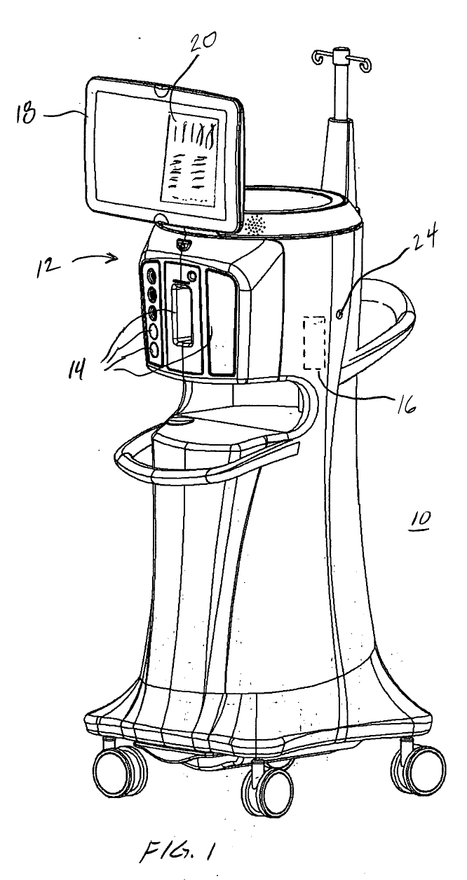

FIG. 1 shows an ophthalmic surgical system 10, in accordance with the present invention. System 10 includes an ophthalmic surgical console, generally shown at 12. Console 12 includes a plurality of surgical modules 14 for performing a plurality of surgical tasks. Surgical console 12 also preferably includes a computer (not shown) that includes a memory 16, shown as a dashed line. A display screen 18 forms a part of the surgical console 12 for displaying a variety of surgical information and information contained within the memory 16. The display screen 18, in accordance with the present invention, also displays a catalog of products stored in the memory 16 that may be purchased for use with the surgical console 12 and the plurality of surgical modules 14.

A display page shown at 20, shows an example of a page of a catalog of products that may be purchased for use with surgical system 10.

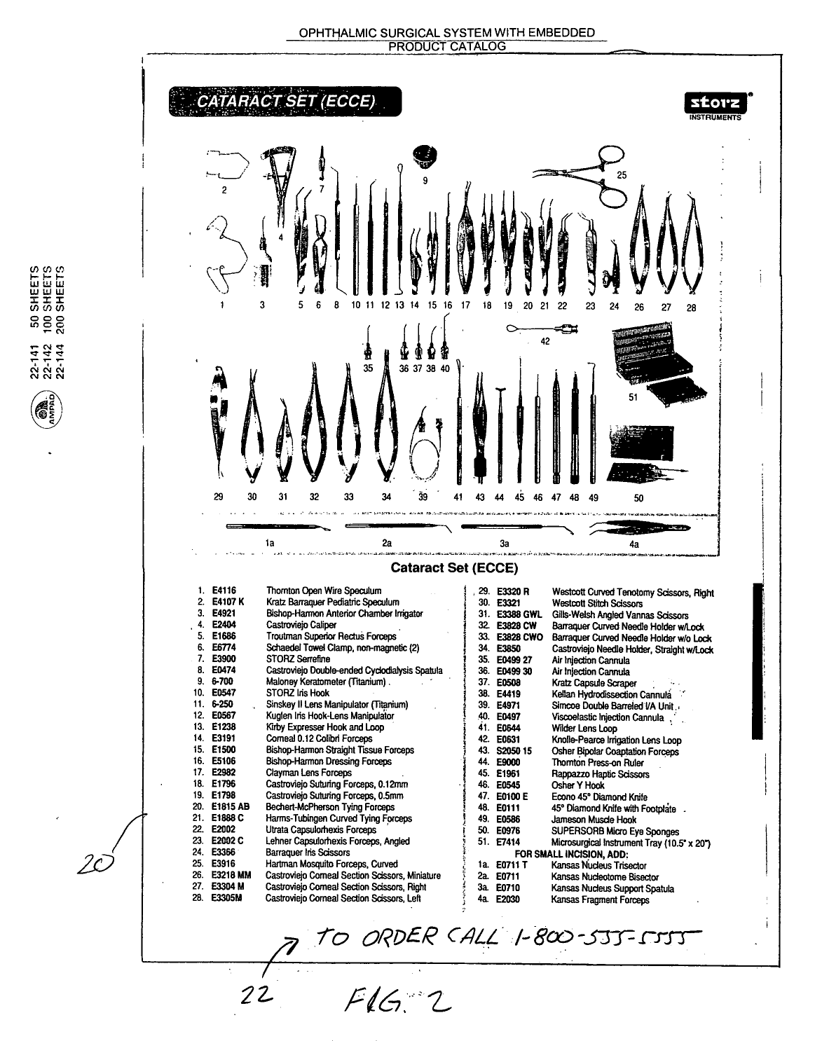

FIG. 2 shows the display page 20 in more detail, showing a wide range of instruments for use with a surgical system 10. Display page 20 also preferably includes information shown at 22 instructing a user to order the products on display page 20. Display page 20 is but a single example of what may be several hundred pages of products forming the product catalog.

Surgical console 12 is preferably connectable to an internet, such as via a wireless connection 24, shown in FIG. 1. The catalog of products may be periodically updated via the internet by the manufacturer. While a wireless internet connection is shown, those skilled in the art will appreciate that a hard-wired connection or other devices, such as DVD/CD players or other suitable data devices may be used to store a product catalog within system 10 for display on display screen 18. For the purposes of the present invention, memory should be defined as a wide variety of data storage devices, such as a hard-disk drive, flash memory, DVD and CD recorder players, magnetic storage media, or any other known data storage device suitable for containing a catalog of products, including images of the products for display on display screen 18 in surgical system 10.

It is also possible for individual advertisements of products associated with system 10 to be displayed. These advertised products could be new products or products that may be on sale.

I claim:

1. An ophthalmic surgical system comprising:
an ophthalmic surgical console including a plurality of surgical modules for performing a plurality of surgical tasks;
wherein the surgical console includes a memory;
a display screen forming a part of the surgical console for displaying a variety of surgical information and information contained within the memory; and
wherein the display screen displays a catalog of products stored in the memory that may be purchased for use with the surgical console and the plurality of surgical modules.

2. The system of claim 1, wherein the surgical console is connectable to an internet and the catalog may be periodically updated via the internet.

3. The system of claim 1, wherein the catalog includes images of the products.

4. The system of claim 1, further including displaying an advertisement of a product associated with the surgical system.
